(19) United States
(12) Patent Application Publication
(10) Pub. No.: US 2024/0343928 A1
(43) Pub. Date: Oct. 17, 2024

(54) Coatings with Discrete Carbon Nanotubes for Energy Storage and Additive Manufacturing

(71) Applicant: Molecular Rebar Design, LLC, Austin, TX (US)

(72) Inventor: Clive Paul Bosnyak, Dripping Springs, TX (US)

(21) Appl. No.: 18/633,960

(22) Filed: Apr. 12, 2024

Related U.S. Application Data
(60) Provisional application No. 63/459,007, filed on Apr. 13, 2023.

(51) Int. Cl. C09D 7/62; B33Y 70/10; C08K 3/013; C08K 3/02; C08K 3/22; C08K 9/08; C09D 7/40; H01F 1/14; H01M 4/02; H01M 4/36; H01M 4/38; H01M 4/525; H01M 4/62

(52) U.S. Cl. CPC C09D 7/62; B33Y 70/10; C09D 7/69; C09D 7/70; H01F 1/14; H01M 4/366; H01M 4/386; H01M 4/525; H01M 4/625; C08K 3/013; C08K 2003/023; C08K 2003/2293; C08K 9/08; C08K 2201/001; C08K 2201/003; C08K 2201/004; C08K 2201/01; C08K 2201/011; H01M 2004/027; H01M 2004/028

(57) ABSTRACT

Novel coating compositions are disclosed for use in Energy Storage devices and Additive Manufacturing. The coatings are comprised of discrete carbon nanotubes wherein the coatings have a selected range of porosity, and optionally the discrete carbon nanotubes have selected surface modifications to improve wetting or flow of material through the pores of the carbon nanotube coating. The coatings have less than about 20% mass of bundles or ropes of carbon nanotubes with a dimension larger than about 5 micrometers The coatings are of average thickness from about 5 nanometers to about 2000 nanometers and can be applied onto particles of diameter less than about 1000 micrometers, or films. Improved energy storage, or additive part performances include, but not limited to, higher electron conductivity for electrodes of energy storage devices, and higher electron conductivity for parts made by additive manufacturing. The coatings are particularly suitable for additive manufacturing of energy storage devices, and electrodes made using a dry electrode process.

### CROSS-REFERENCE TO RELATED APPLICATIONS

The present application claims priority to U.S. provisional application Ser. No. 63/459,007 filed on Apr. 13, 2023 which application is incorporated herein by reference.

### TECHNICAL FIELD

The present disclosure relates generally to novel compositions of coatings of discrete carbon nanotubes on particles, or planar-like surfaces such as films or sheets wherein the coatings have a selected range of porosity and thickness, and optionally the discrete carbon nanotubes have selected surface modifications to improve sintering, wetting or flow of material through the pores of the carbon nanotube coating. Furthermore, the coatings of carbon nanotubes comprise less than about 20% of the mass of the coating in the form of highly entangled bundles or ropes of carbon nanotubes wherein the bundles or ropes of carbon nanotubes have at least one dimension of size larger than about 5 micrometers. These coatings provide improved performance in energy storage devices, and for additive manufacturing of energy storage devices, or other articles using additive manufacturing, particularly those additive manufacturing processes employing a laser.

### BACKGROUND AND SUMMARY

Carbon nanotubes (CNTs) can be classified by the number of walls as single-wall, double wall and multiwall. Each wall of a CNT can be further classified into chiral or non-chiral forms. Some of the carbon atoms of the CNT may be substituted by nitrogen atoms. Some of the walls may contain Stone-Wales defects which are defined as heptagon-pentagon pairs. CNTs are currently manufactured at large tonnage using chemical vapor deposition reactors which produces agglomerated bundles or ropes of carbon nanotubes which have very limited commercial use due to their inferior performance as reinforcing fillers in the agglomerated state. Use of CNTs as a reinforcing agent or filler or conductive filler in polymer composites is an area in which CNTs are predicted to have significant utility if they can be made as discrete carbon nanotubes. However, utilization of CNTs in these applications has been hampered due to the general inability to reliably produce discrete or individualized CNTs.

Various methods have been developed to debundle or disentangle CNTs in different media. For example, CNTs may be shortened extensively by aggressive oxidative means and then dispersed as individual nanotubes in dilute solution. However, these tubes have low aspect ratios not suitable for high strength composite materials. CNTs may also be dispersed in very dilute solution as individual tubes by sonication in the presence of a surfactant. Illustrative surfactants used for dispersing CNTs in aqueous solution include, for example, sodium dodecyl sulfate, or cetyltrimethyl ammonium bromide. In some instances, solutions of individualized CNTs may be prepared from polymer-wrapped carbon nanotubes. Individualized single-wall CNT solutions have also been prepared in very dilute solutions using polysaccharides, polypeptides, water-soluble polymers, nucleic acids, DNA, polynucleotides, polyimides, and polyvinylpyrrolidone, but these dilute solutions are uneconomical to employ and unsuitable for energy storage devices or additive manufacturing in general.

Additive Manufacturing (AM) is a suite of technologies that build 3-dimensional objects by processing a material in a layer-by-layer fashion. The material is generally, but not limited to, crosslinkable monomers or oligomers, thermoplastics, metals, ceramics, cement, and biological tissue. AM technologies commonly use a computer, 3D modeling software (Computer Aided Design−CAD), hardware equipment and feedstock material. After a CAD model of the part is produced, the AM hardware translates data from the CAD file and deposits material−liquid, powder, sheets, or other form, in a layer-by-layer pattern to fabricate a 3D object. The term AM encompasses many technologies and is synonymous to 3D Printing, Rapid Prototyping, Direct Digital Manufacturing, layered manufacturing, and additive fabrication.

Numerous materials such as, but not limited to, crosslinkable monomers and oligomers that are crosslinked by such means as, but not limited to, radiation or heat, thermosets and thermoplastic powders, thermoplastic filaments, and hot-melt plastic inks have been used in Additive Manufacturing, (AM); however, there remain many limitations of the AM materials properties such as heat distortion resistance, rigidity, electrical conductivity for shielding of electromagnetic radiation or static electricity management, thermal transport, impact strength and deformation during processing. For example, by employing a coating of discrete carbon nanotubes on a particle the electrical conductivity of the sintered article can be considerably enhanced. In batteries, the ion-active cathode and anode materials are often particles that are highly compressed and joined with small amounts of binder to form layers. The porosity of the cathode and anode layers is very important to control as this porosity strongly influences the ability to transport ions by the electrolyte throughout the layer. It is highly desirable to maintain and control porosity around each and every particle which can be provided by coatings of this invention.

The general purpose of the systems and methods disclosed herein is to provide novel compositions of coatings of discrete carbon nanotubes on particles, or planar-like surfaces such as films or sheets wherein the coatings have a selected range of porosity and thickness, and optionally the discrete carbon nanotubes have selected surface modifications to improve joining, sintering, wetting or flow of material through the pores of the carbon nanotube coating. Furthermore, the coatings of discrete carbon nanotubes comprise less than about 10% of the mass of the coating in the form of highly entangled bundles or ropes of carbon nanotubes wherein the bundles or ropes of carbon nanotubes have at least one dimension of size larger than about 5 micrometers. These coatings provide improved performance in energy storage devices and for additive manufacturing of energy storage devices, or other articles using additive manufacturing, particularly those additive manufacturing processes employing a laser. The coating compositions are designed to work in conjunction with a large variety of battery assembly processes as well as additive manufacturing processes and techniques. The coatings of this invention can improve the electron, ion, and thermal transport of anodes and cathodes as well as the electrolyte. In addition, the coatings of this invention can be employed to improve the strength of materials comprising the battery.

The coatings can also be used with inorganic materials such as, but not limited to, calcium carbonate, talc, magnesium carbonate, Wollastonite, glass beads, glass fibers, glass flakes, fly ashes, silica, dolomite, barium sulfate, aluminum hydroxide, halloysite, zinc oxide, titanium oxide, mica and hematite. The coated inorganic fillers can be employed as additives to monomers and polymers that are elastomers, thermoplastic, thermoset and combinations thereof and processed by such means as, but not limited to, extrusion, injection molding, casting, thermoforming, blow molding, rotational molding, film forming, pultrusion, and filament winding.

Additive manufacturing can be employed in the manufacture of energy storage devices, i.e., batteries, such as, but not limited to, lithium-ion batteries and sodium-ion batteries. The components of the batteries, casings, current collectors, anode and cathode, separator and gel and solid electrolyte are all envisioned to be potentially manufactured by AM.

One general aspect includes coatings of particles, strands or planar surfaces with a thickness from about 5 nanometers to about 2000 nanometers on particles of average diameter less than about 1000 micrometers where the coating is selected from the group of discrete carbon nanotubes.

The particles are selected from the group of organic polymers and inorganic species. The organic polymers are selected from the group of elastomers with a glass transition temperature below about 25 degrees centigrade, and polymers with a glass transition temperature above about 25 degrees centigrade. The inorganic species are selected from the group consisting of silicon, sulfur, carbon, ceramics, metals, metal oxides, metal salts and mixtures thereof. Inorganic particles useful for cathodes of lithium-ion batteries include, but not limited by, nickel-manganese cobalt oxide and lithium iron phosphate. A ceramic is a nonmetallic and inorganic substance.

The coating has a porosity (porosity defined as void fraction or that fraction of open space relative to the whole volume of the carbon nanotube coating) of about 0.05 to about 0.95. The main property that defines a pore is its size, that is, its spatial dimension. The pore size of a material can also be described by the pore distribution. Convenient analysis tools to measure the porosity are scanning electron microscopy or mercury porosimetry. Mercury porosimetry is based on the intrusion of mercury into the porous structure of a material through the application of isostatic pressure. The technique is based on the Washburn equation. This equation relates the pressure applied to the diameter of the pore into which the mercury is introduced. Mercury porosimetry provides information on pores with a range of size from about 900 microns to about 4 nanometers in diameter.

A further aspect of the porosity of the coatings with discrete carbon nanotubes is that the pores are interconnected to allow more free passage of materials, such as gases, and liquids, such as but not limited to, electrolytes, molten polymers, metals and metal alloys.

The discrete carbon nanotubes are selected from a group of single wall, double wall or multiwall carbon nanotubes and mixtures thereof. The modality of aspect ratio of the discrete carbon nanotubes can be monomodal or at least bimodal. At least a portion of the carbon nanotubes are of length greater than about 0.2 micrometers, preferably of length greater than about 0.5 micrometers and more preferably greater than about 0.8 micrometers.

The coatings of discrete carbon nanotubes cover at least about 50% of the available particle surface area, preferably at least about 75% of the surface area of the available particle surface area, more preferably at least about 90% of the surface area of the available particle surface area, and most preferably at least about 95% of the surface area of the available particle surface area.

The coated particles may represent a portion of the particles, i.e., there can be a mixture of uncoated and coated particles. The fraction of coated particles relative to the particles present can be at least about 5% by weight, preferably at least about 10% by weight, more preferably at least about 25% by weight, even more preferably at least about 50% by weight, and most preferably at least about 75% by weight.

The discrete carbon nanotubes are preferably uniformly dispersed with less than about 20% of the mass of the carbon nanotubes present in the coating in the form of bundles or ropes of carbon nanotubes on a dimension scale larger than about 5 micrometers, more preferably less than about 10% of the mass of the carbon nanotubes present in the coating in the form of bundles or ropes of carbon nanotubes on a dimension scale larger than about 5 micrometers, even more preferably with less than 5% of the mass of the carbon nanotubes present in the coating in the form of bundles or ropes of carbon nanotubes on a dimension scale larger than about 5 micrometers, and most preferably with less than 2% of the mass of the carbon nanotubes present in the coating in the form of bundles or ropes of carbon nanotubes on a dimension scale larger than about 5 micrometers.

The composition may include carbonaceous material selected from the group of carbon black, carbon fibers, graphite, graphene, turbostratic graphene, reduced graphene, carbon nanorods and graphene oxide. Turbostratic graphene is a multilayer graphene, which has electrical properties similar to those of monolayer graphene due to the low interlayer interaction. Additionally, the stacking structure of the turbostratic multilayer graphene can decrease the effect of attachment of charge impurities and surface roughness. The ratio of discrete carbon nanotubes to carbonaceous material selected from the group of carbon black, carbon fibers, graphite, graphene, reduced graphene, turbostratic graphene, carbon nanorods and graphene oxide is in the range about 1:99 to about 99:1 by weight. A part made by sintering particles, powders or strands with the coating compositions has a surface resistance of less than about 10 billion ohms-square, preferably less than about 10 million ohm-square, more preferably less than about 10,000 ohm-square and most preferably less than about 1000 ohm-square.

The composition may include magnetic or paramagnetic materials. Electromagnetic Interference, EMI, shielding may be important in electronics and telecommunication as electromagnetic interference can, for example, damage electronic chips, or create problems in signal amplification. Magnetic or paramagnetic materials can absorb electromagnetic radiation and are particularly useful at, but not limited to, radiation frequencies greater than about 2 GHz. A part made by sintering particles, powders or strands with the coating compositions containing magnetic or paramagnetic materials may show at least about 5 dB improvement at 2 GHz frequency compared to coatings without the magnetic or paramagnetic materials. The magnetic or paramagnetic materials may be attached to the discrete carbon nanotubes.

The composition also includes coatings of a thickness from about 5 nanometers to about 2000 nanometers on particles of average diameter less than about 1000 micrometers or on surfaces such as, but not limited to, current collectors within batteries where the coating is selected from the group of discrete carbon nanotubes and optionally may include surface modification of the discrete carbon nanotubes.

The surface modification of the discrete carbon nanotubes can be made using covalent, ionic or hydrogen bonding of molecular entities selected from the group consisting of molecules comprising oxygen, silicon, titanium, zirconium, sulfur, phosphorous or nitrogen elements. The discrete carbon nanotubes further may include a surface modification selected from the group consisting of anionic, cationic, nonionic and zwitterionic surfactants, polyvinyl alcohols, copolymers of polyvinyl alcohols and polyvinyl acetates, polyvinylpyrrolidones and their copolymers, carboxymethyl cellulose, carboxypropyl cellulose, carboxymethyl propyl cellulose, hydroxyethyl cellulose, polyetherimines, polyethers, starch, and mixtures thereof.

The surface modification has a value of Hansen Solubility Parameter dispersion parameter within about 2 J^{0.5} m^{-1.5} the value of the Hansen dispersion parameter of the polymer particle or strand. The discrete carbon nanotube surface modification can be miscible with a polymer particle or strand. The surface modification may also allow chemical interaction between the composition of the particle and the surface modification. For example, but not limited, the discrete carbon nanotubes can be oxidized to provide carboxylic acid groups which may react with other molecules such as, but not limited to, polymers such as a polyamide, or polyester, or inorganic materials such as, but not limited to calcium carbonate, talc, halloysite, mica and hematite. The surface modification can be at least partially removed, or partially modified, during heat treatment of the particle, for example, for sintering or joining the particles. With ceramics where sintering can occur at temperatures above the degradation temperature of the carbon nanotubes, the coatings can serve to provide sub-micrometer channels for gaseous transport.

There is a continuing need to improve the performance-cost ratio of energy and collection devices such as, but not limited to batteries, capacitors, and photovoltaics. Performance gains can be made by materials selection and design of the device while costs can be reduced by using lower cost or less amounts of materials, the design of the device and improvements in manufacturing. In energy storage devices like batteries and capacitors, reducing the manufacturing energy and labor consumption and increasing electrode thickness are two effective methods to lower the manufacturing costs. The fabrication of electrodes for lithium-ion batteries, for example, with a conventional slurry-casting method involves mixing the active material, such as a nickel-manganese-cobalt oxide for the cathode, a polymer that binds the active material, and a conductive additive, such as carbon black, N-methyl-pyrrolidone (NMP). After several hours of mixing, the slurry is cast on the current collector, dried, and calendered to form electrodes. NMP is a commonly used organic solvent in cathode fabrication, while water is commonly used for anode where the active material is commonly graphite. An oven, dozens of meters long, with a temperature higher than 120° C. is required in the process of drying for both anode and cathode. The energy consumed in slurry making and coating, together with solvent recovery for NMP, can account for as much as 50% of individual device production. Thus, a non-solvent or dry process is an attractive proposition to reduce the cost of making energy storage or collection devices.

There are several approaches possible to create a solvent free process for an electrode including laser technology, radio-frequency magnetron sputtering, dry-spraying, electro-static spray deposition and mixing of the electrode active material with additives to help bind the particles. The mixing of the electrode active material with polymer binders and further processing, such as hot calendering, is considered the lowest cost manufacturing route and is easily scalable to large production.

Polytetrafluorethylene (PTFE) has also been demonstrated for solvent free electrode fabrication. For example, in a published article Yang et al. fabricated a silicon oxide anode with PTFE and polyvinylidene fluoride (PVDF) where PTFE, PVDF, silicon oxide and acetylene black were dry mixed and pressed to form the final electrodes [Yang, J.; Takeda, Y.; Imanishi, N.; Capiglia, C.; Xie, J.; Yamamoto, O. SiOx-based anodes for secondary lithium batteries. Solid State Ion. 2002, 152, 125-129.]

U.S. Pat. No. 8,072,734 B2 disclosed an inexpensive and reliable dry process-based capacitor method for making a self-supporting dry electrode film. Also disclosed in U.S. Pat. No. 8,072,734 B2 is an exemplary process for manufacturing an electrode for use in an energy storage device product, the process comprising supplying dry carbon particles, supplying dry binder, dry mixing the dry carbon particles and dry binder; and dry fibrillizing the dry binder to create a matrix within which to support the dry carbon particles as dry material. The binder employed to fibrillize is a fluoropolymer such as polytetrafluoroethylene, PTFE. Where high shear processes are involved, PTFE can be stretched to form fiber under high shear, which can act as a net to support active material and conductive additives. The mixture of the electrode component is hot-rolled after mixing under high shear to form a free-standing film and finally laminated with the current collector using hot-rolling again. PTFE, however, is considered by some to be unsuitable for the anode of lithium-ion batteries due to its oxidative instability when applied in anodes. The energy level of the lowest unoccupied molecular orbitals (LUMO) of PTFE is relatively low, which implies that PTFE accepts electrons readily, making it electrochemically unstable in an anodic environment.

It has been found that carbon nanotubes can be used to improve the conductivity of the cathode in the usual cathode making slurry process with NMP as a solvent medium for the PVDF, or in an anode which conventionally employs water-based slurries of graphite and silicon, for example. U.S. Pat. No. 8,808,909 B2 describes adding discrete carbon nanotubes to enhance the performance of energy storage or collection devices. For the cathode, a general procedure is the carbon nanotubes are passed through high shear equipment at concentrations less than about 4% weight in the NMP and added to the lithium active cathode material together with polyvinylidene difluoride, PVDF, as a binder and additional conductive carbon black. A common formulation might be to add 3% wt. PVDF, 1% wt. multiwall carbon nanotube and 3% wt. carbon black relative to nickel manganese cobalt oxide, NMC. As the slurry is dried the PVDF, carbon black and carbon nanotubes associate and form regions of adhesion between the NMC particles and also bind the NMC particles to the aluminum current collector. Consequently, the carbon nanotubes by this method do not coat the particles of NMC more than about 20% of the available surface area of NMC. Additionally, the void content of the PVDF carbon black carbon nanotube composite is zero.

It is considered advantageous to be able to more fully coat the cathode and anode materials with discrete carbon nanotubes of this invention to enhance the electron and ion-transfer and thereby improve the battery performance. Although not bound by theory, it is surmised that the coating of discrete carbon nanotubes on the electroactive material allow for a more uniform potential gradient throughout the electrode and thus battery with longer cycle life than a battery made without the coating of discrete carbon nanotubes. It is further desirable for the coating to be porous to electrolyte. The coating of discrete carbon nanotubes may be on a separator film of a battery or on the copper or aluminum current collectors. The coating of discrete carbon nanotubes may be applied to lithium foil.

In the electrode process employing n-methylpyrrolidone it is desirable to use a surface modification of the discrete carbon nanotube that is not soluble in the n-methylpyrrolidone, for example, but not limited to, the surface modification of the carbon nanotube is sodium carboxymethylcellulose.

In the dry electrode process for making a battery or capacitor, the coating of the electroactive particles may be applied via liquid media, prior to the coated particle being employed in the dry electrode process.

### BRIEF DESCRIPTION OF THE DRAWINGS

FIG. 1. An electron micrograph of a dried coating of discrete oxidized multiwall carbon nanotubes demonstrating the porosity of the coating and the presence of many open ends of the discrete oxidized carbon nanotubes. Magnification is 250,000×.

FIG. 2. An electron micrograph at 50,000 magnification of discrete oxidized carbon nanotube coating on a powder particle of Vestasint 3054D. The discrete carbon nanotubes are coated with polyvinylpyrrolidone, molecular weight 10,000 daltons at 50% wt. relative to the discrete oxidized carbon nanotubes. The polyvinylpyrrolidone is seen as globules approximately 20 to 40 nanometers in diameter at the tube surface. Magnification is 50,000×.

FIG. 3. An electron micrograph of 0.1% wt. coating of discrete carbon nanotubes on Vestasint 3054D. Magnification is 10,000×.

FIG. 4. A thermogram of Vestasint 3054D powders heating to sinter the particles, then cooling and reheating.

FIG. 5. A thermogram of Vestasint 3054D powders with a 2% wt. discrete multiwall carbon nanotube coating heating to sinter the particles, then cooling and reheating.

FIG. 6. An electron micrograph of a coating of discrete carbon nanotubes on Luvosint HTN particle. The coating is 0.25% wt. discrete oxidized multiwall carbon nanotubes with a polyvinylalcohol dispersant. Magnification is 20,000×.

FIG. 7. An electron micrograph of a coating of discrete multiwall carbon nanotubes on Luvosint HTN particle. The coating is 0.5% wt. discrete oxidized carbon nanotubes with a polyvinylalcohol dispersant. The coating is partially removed from the powder surface of Luvosint HTN to determine the thickness of the coating. Magnification is 20,000×.

FIG. 8. An electron micrograph, magnification 20,000×, of a coating of discrete single wall carbon nanotubes on a silicon particle employed as an anode electroactive material in lithium-ion batteries.

FIG. 9. An electron micrograph, magnification 20,000×, of a coating of discrete single wall carbon nanotubes on a nickel-manganese-cobalt oxide (BASF NMC 523) particle employed as a cathode electroactive material in lithium-ion batteries.

### DETAILED DESCRIPTION OF THE INVENTION

In the following description, certain details are set forth such as specific quantities, sizes, etc., so as to provide a thorough understanding of the present embodiments disclosed herein. However, it will be evident to those of ordinary skill in the art that the present disclosure may be practiced without such specific details. In many cases, details concerning such considerations and the like have been omitted inasmuch as such details are not necessary to obtain a complete understanding of the present disclosure and are within the skills of persons of ordinary skill in the relevant art.

While most of the terms used herein will be recognizable to those of ordinary skill in the art, it should be understood, however, that when not explicitly defined, terms should be interpreted as adopting a meaning presently accepted by those of ordinary skill in the art. In cases where the construction of a term would render it meaningless or essentially meaningless, the definition should be taken from Webster's Dictionary, 3rd Edition, 2009. Definitions and/or interpretations should not be incorporated from other patent applications, patents, or publications, related or not.

Functionalized, alternatively called surface modified, carbon nanotubes of the present disclosure generally refer to the modification of any of the carbon nanotube types described hereinabove, or hereafter. Such modifications can involve the nanotube ends, sidewalls inside and/or outside, or both. Modifications may include, but are not limited to covalent bonding, ionic bonding, chemisorption, intercalation, surfactant interactions, polymer wrapping, cutting, solvation, and combinations thereof. In some embodiments, the carbon nanotubes may be functionalized before, during and after being individualized or exfoliated.

Any of the aspects disclosed in this application with discrete carbon nanotubes may also be modified within the spirit and scope of the disclosure to substitute other tubular and non-tubular nanostructures, including, for example, organic, inorganic, or mineral nanotubes, planar nanostructures, and/or other nanostructures. Inorganic or mineral nanotubes include, for example, silicon nanotubes, boron nitride nanotubes and carbon nanotubes having heteroatom substitution in the nanotube structure. The nanotubes may include or be associated with organic or inorganic elements such as, for example, carbon, silicon, boron, and nitrogen. Association may be on the interior or exterior of the inorganic or mineral nanotubes via Van der Waals, ionic or covalent bonding to the nanotube surfaces. Planar nanostructures include substantially planar carbon compounds such as graphene and similar structures composed of or including silicon, boron nitride, and carbon structures having heteroatom substitution in the nanostructure. These planar nanostructures may include or be associated with organic or inorganic elements such as, for example, carbon, silicon, boron and nitrogen. Association may be on either or both surfaces of the planar nanostructure via Van der Waals, ionic or covalent bonding to the planar nanostructure surfaces. Other nanostructures include three-dimensional carbon structures such as fullerenes and similar structures composed of or including silicon, boron nitride, and carbon structures having heteroatom substitution in the nanostructure. These other nanostructures may also include or be associated with organic or inorganic elements such as, for example, carbon, silicon, boron, and nitrogen. Association may be on the interior or exterior of the nanostructure via Van der Waals, ionic or covalent bonding to the nanotube surfaces.

In various embodiments, discrete, or individual, carbon nanotubes are disclosed comprising single wall, double wall or multi wall carbon nanotubes with length greater than about 200 nanometers. The aspect ratio is defined as the length of an individual carbon nanotube divided by its diameter. In some cases, the carbon nanotubes are not linear and so an effective aspect ratio can be defined as the effective length over the effective diameter. The effective aspect ratio is generally less in value than the actual aspect ratio of an individual carbon nanotube. To define the aspect ratio of a carbon nanotube requires determination of the length and diameter of the same carbon nanotube. In most cases there is a distribution of lengths and diameters which can be used to define a distribution of lengths, diameters, or aspect ratios. With single wall carbon nanotubes the single wall carbon nanotubes have strong energetics of association along their length and so easily form ropes containing many individual single wall carbon nanotubes. The resultant diameters of the ropes can be up to several micrometers in size. Thus, the effective diameter of single wall carbon nanotubes can be considered to be up to several micrometers in size. In another example, a bundle of carbon nanotubes has an effective aspect ratio in composites of the average length of the bundle divided by the bundle diameter. The curvature of the carbon nanotubes can be selected to obtain coatings of carbon nanotubes with different porosities and pore sizes.

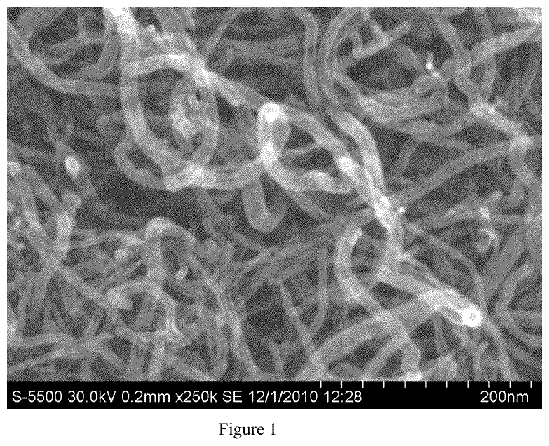

Theoretically one considers fusion between two polymer particles when polymer molecules have diffused across the interparticle boundary to a distance of at least 1 radius of gyration of the polymer. In practice this minimum value of the interparticle boundary of fused thermoplastics is usually in the range of 10 nanometers. Without going into the equations involving thermodynamics and viscosity with temperature and pressure for this diffusion phenomenon it is known practically that with low viscosity polymers in the melt, such as Nylon, this diffusion can occur quickly, i.e., seconds. The radius of gyration for nylon molecules is in the range of 4-5 nm. This radius of gyration value for nylon is well below the average mesh or pore size of the random multiwall carbon nanotube arrays as shown in FIG. 1, which means the low viscosity molten polymers should be able to flow through the discrete carbon nanotube porous mesh. Using bundles of carbon nanotubes where the size of the bundle is greater than about 2 micrometers would present great difficulty for polymer melts to flow through the entire bundle. The use of well-dispersed discrete carbon nanotubes allows uniform coatings onto particles or strands with coating thicknesses less than about 2 micrometers. The surface of the carbon nanotube and the modification of the surface of the carbon nanotube when employed also has a key role to play for sintering polymer particles or flow of material through the carbon nanotube coating. If the thermodynamics or surface tension of the carbon nanotube surface or modified carbon nanotube surface is similar to the polymer particle being sintered and there is at least some inter-connecting voids, then polymer permeation through the coating should be less hindered than if there was a large difference in the thermodynamics or surface tension. In some cases, the dispersant on the carbon nanotubes may be selected to be able to diffuse into the material of the particle to be sintered.

The carbon nanotubes can be oxidized with oxidizing agents to provide carboxylic acid groups, hydroxyl groups, ketones and lactones with an overall (total) oxidation level of from about 0.1 weight percent to about 15 weight percent of the carbon nanotubes, preferably from about 0.5 weight percent to about 10 weight percent, more preferably from about 1 weight percent to 5 weight percent, more preferably from about 1 weight percent to 3 weight percent of the carbon nanotubes. Using a TA TGA Q50 instrument, the thermogravimetric method, TGA, for the determination of the percent weight of oxygenated species on the carbon nanotube involves taking about 7-15 mg of the dried oxidized carbon nanotube and heating at 5° C./minute from 100 degrees centigrade to 700 degrees centigrade in a dry nitrogen atmosphere. The percentage weight loss from 200 to 600 degrees centigrade is taken as the percent weight loss of oxygenated species. The oxygenated species can also be quantified using Fourier transform infra-red spectroscopy, FTIR, particularly in the wavelength range 1730-1680 cm⁻¹.

The carbon nanotubes can also comprise oxygen containing species with molecular weight above about 100 daltons, such as, but not limited to, polyethers, polyamides, polyurethanes, polyesters and polyketones. In these cases the amount of the oxygen containing species can be in the range of about 1 to about 80% by weight of the carbon nanotubes, preferably be in the range of about 1 to about 70% by weight of the carbon nanotubes, more preferably be in the range of about 2 to about 50% by weight of the carbon nanotubes and most preferably in the range of about 3 to about 50% by weight of the carbon nanotubes. Typically, the amount of discrete carbon nanotubes after completing the process of oxidation and shear is in the majority (that is, a plurality) and can be as high as 70, 80, 90 or even 99 percent of discrete carbon nanotubes based on the total number of nanotubes, with the remainder of the tubes still partially entangled in some form. Complete conversion (i.e., 100 percent) of the nanotubes to discrete individualized tubes is most preferred. The carboxylic and hydroxyl groups can be used to react with a variety of chemical entities, such as but not limited to, amines, silanes, isocyanates, glycidyl, anhydrides, titanates, and acyl chlorides to provide other chemical modifications to the carbon nanotubes.

The discrete carbon nanotubes may further comprise a dispersing agent or surfactant, adhesively, ionically, or covalently bonded to the discrete carbon nanotube surface. The surfactant may be a biocompatible surfactant. The surfactant molecule can be chosen such that the size of the surfactant molecule in the liquid media prevents it from entering within the discrete carbon nanotube itself. The selection of the minimum size of the surfactant molecule that cannot enter into a tube opening is related to the diameter of the tube opening and the hydrodynamic radius of the molecule in the liquid media.

The bundled, or roped, carbon nanotubes can be made from any known means such as, for example, chemical vapor deposition, laser ablation, and high-pressure carbon monoxide synthesis. The bundled carbon nanotubes can be present in a variety of forms including, for example, soot, powder, fibers, and bucky paper. Furthermore, the bundled carbon nanotubes may be of any length, diameter, or chirality. Carbon nanotubes may be metallic, semi-metallic, semi-conducting, or non-metallic based on their chirality and number of walls. The discrete oxidized carbon nanotubes may include, for example, single-wall, double-wall carbon nanotubes, or multi-wall carbon nanotubes and combinations thereof. One of ordinary skill in the art will recognize that some of the specific aspects of this invention illustrated utilizing a particular type of carbon nanotube may be practiced equivalently within the spirit and scope of the disclosure utilizing other types of nanotubes such as those containing boron or nitrogen or silicon atoms. However, for control of the desired structures of a plurality of discrete carbon nanotubes requires a specific control of chemistry, thermal and mechanical energy which varies according to the starting structure of the carbon nanotubes.

One particular for forming carbon nanotubes of this invention is the incorporation of a portion of structures called Stone-Wales defects which are the rearrangement of the six-membered rings of graphene into heptagon-pentagon pairs that fit within the hexagonal lattice of fused benzene rings constituting a wall of the carbon nanotubes. These Stone-Wales defects are useful to create sites of higher bond-strain energy for more facile oxidation of the graphene or carbon nanotube wall. These defects and other types of fused ring structures may also facilitate bending or curling along the length of the carbon nanotubes.

Stone-Wales defects are thought to be more prevalent at the end caps that allow higher degrees of curvature of the walls of carbon nanotubes. During oxidation the ends of the carbon nanotubes can be opened and also result in higher degrees of oxidation at the opened ends than along the walls. The higher degree of oxidation and hence higher polarity or hydrogen bonding at the ends of the tubes are thought useful to help increase the average contour length to end to end ratio where the tubes are present in less polar media such as oil. The ratio of the contour length to end to end distance can be advantageously controlled by the degree of thermodynamic interaction between the tubes and the medium. Surfactants and electrolytes can be usefully employed also to modify the thermodynamic interactions between the tubes and the medium of choice. Alternate means to influence the ratio of contour length to end to end ratio include the use of inorganic or ionic salts and organic containing functional groups that can be attached to or contacted with the tube surfaces.

Carbon nanotubes are obtainable in the form of bundles, highly entangled agglomerates, or ropes, from different sources, such as CNano Technology, Nanocyl, Arkema, OCSiAl, LG Chem and Kumho Petrochemical. The carbon nanotubes are made using metal catalysts containing elements such as, but not limited to, iron, aluminum or cobalt, and can retain a significant amount of the catalyst associated or entrapped within the carbon nanotube, as much as about five weight percent or more. These residual metals can be deleterious in such applications as thermoplastic molding compounds where the metals cause accelerated thermal decomposition of the polymers or drug delivery, treatment, imaging, and/or diagnostics because of such residual metals may not be biocompatible. Furthermore, on oxidation of the carbon nanotubes these divalent or multivalent metal ions can associate with carboxylic acid groups on the carbon nanotube and interfere with the discretization of the carbon nanotubes in subsequent dispersion processes. Preferably, the oxidized carbon nanotubes comprise a residual metal concentration of less than about 25,000 parts per million, ppm, and preferably less than about 5,000 parts per million. The metals composition and concentration can be conveniently determined using energy dispersive X-ray spectroscopy or thermogravimetric methods.

An example of a method to produce discrete carbon nanotubes having targeted oxidation is as follows. A mixture of 0.5% to 5% carbon nanotubes, preferably 3%, by weight, is prepared with CNano grade Flotube 9000 carbon nanotubes and nitric acid. CNano Flotube 9000 carbon nanotubes are multiwall carbon nanotubes with an average diameter of 13 nm. The acid can also be a mixture of sulfuric acid and nitric acid. Preferably the initial nitric acid concentration is greater than about 65% nitric acid. Other oxidizing media such as, but not limited to, potassium permanganate, or hydrogen peroxide may be employed. The as-received CNano Flotube 9000 has a morphology similar to entangled balls of wool. While stirring, the nitric acid and carbon nanotube mixture is heated to 70 to 90 degrees Centigrade for 2 to 4 hours. The formed oxidized carbon nanotubes are then isolated from the acid mixture. The oxidized carbon nanotubes are predominately in the form of entangled bundles. Several methods can be used to isolate the oxidized carbon nanotubes, including but not limited to centrifugation, filtration, mechanical expression, decanting and other solid—liquid separation techniques. The residual acid is then removed by washing the oxidized carbon nanotubes with an aqueous medium such as water, preferably deionized water, to a pH value between 3 and 4. The carbon nanotubes are then suspended in water at a concentration of about 0.5% to about 4%, preferably about 1.5% by weight. The solution is subjected to intensely disruptive forces generated by shear (turbulent) and/or cavitation with process equipment capable of producing energy densities up to about 108 Joules/m³. Equipment that meets this specification includes, but is not limited to, ultrasonicators, cavitators, mechanical homogenizers, pressure homogenizers and microfluidizers. Typically, based on a given starting amount of entangled as-received and as-made carbon nanotubes, a plurality of discrete oxidized carbon nanotubes results from this process, preferably at least about 60%, more preferably at least about 75%, most preferably at least about 95% and as high as 100% based on the total number of nanotubes as opposed to total nanotube weight, with the minority of the tubes, usually the vast minority of the tubes remaining entangled, or not substantially individualized. As one of ordinary skill in the nanotube art appreciates since at least about 2010 “plurality” has been used in this art to mean more than any other. That is, there is a greater number of nanotubes that are discrete than in, for example, aggregated as bundled or ropes in a representative sample. A plurality of discrete oxidized carbon nanotubes may be wherein an amount of oxidized discrete carbon nanotubes is greater than about 50% based on the total number of all the carbon nanotubes present. If desired, the oxidation, for example with acid, may be performed in the presence of a high energy mixer to give higher weight fractions of oxidized discrete carbon nanotubes before filtering and washing. Furthermore, after removal of the acid the catalyst residue originally present in the as manufactured carbon nanotubes is reduced.

With single wall carbon nanotubes, the single wall carbon nanotubes are more difficult to obtain as discrete entities than multiwall carbon nanotubes. This is because of the necessity to de-rope the single wall carbon nanotubes. A convenient method to obtain discrete single wall carbon nanotubes is to utilize surface modifications to the single wall carbon nanotubes with or without high energy dispersion techniques. For example, oxidized discrete single wall carbon nanotubes are obtained by treating a 0.2% wt. suspension of single wall tubes (OCSiAl, Tuball) in 90% concentrated nitric acid at 90° C. for 3 hours while sonicating using a sonicator probe. After removal of the acid by filtering and washing to pH less than about 4, the oxidized single wall carbon nanotubes can be dispersed in water using surfactants such as, but not limited to, sodium carboxymethyl cellulose at weight ratios of surfactant to discrete single wall carbon nanotube where the porosity is greater than about 0.05 and less than about 0.95 in the dried coatings.

Powder bed fusion is one of seven Additive Manufacturing processes, in which either laser, heat, or electron beam is used to melt and fuse the material to form a three-dimensional object. The powder bed fusion encompasses various techniques such as direct metal laser sintering (DLMS), selective laser melting (SLM), electron beam melting (EBM), selective laser sintering (SLS), multi jet fusion (MJF), selective heat sintering (SHS), selective absorption fusion (SAF). All these methods fabricate the 3D object by fusion/melting of powdered feedstock.

Polymer powder bed fusion (a.k.a. Laser Sintering or LS) uses laser to fuse thin layers of powdered polymer deposited across the build area by the leveling roller or a blade. The general LS process proceeds as follows: Control software slices the CAD model of the component to be built into individual cross-sectional layers. The build platform lowers one layer thickness; the powder supply indexes upwards to supply powder. A roller or blade picks up a portion of a feedstock powder from the supply chamber and deposits it in a smooth layer over the build platform. The laser scans the cross-section of the component selectively melting the powdered polymer. Portion of the powder bed not irradiated by the laser energy remain a powder. The build chamber moved down one layer thickness; powder supply moves upward to deliver the next powder layer and the process repeats until the build in completed. The part(s) are removed from the powder bed and any un-sintered powder is brushed off.

A common material used in polymer powder bed fusion processing is polyamide (nylons 11 and 12) obtainable from 3D Chimera or Evonik industries. Other commercially available materials include, but not limited to, polyether block amides (PEBA), thermoplastic urethanes (TPU), thermoplastic elastomers (TPE), polypropylene (PP), and high temperature polyaryletherketones (PAEK) which also includes polyetheretherketone, PEEK, polyetherketone (PEK) that are available from Arkema. These polymers are available in powder form from Formlabs. These polymers can also contain other particles known as fillers to improve certain properties such as stiffness. The particles or fillers within the polymer are, for example but not limited to, carbon black, graphene, graphene oxide, reduced graphene oxide, carbon nanotubes, carbon nanorods, glass fiber, glass flake, glass powder, mineral fillers and carbon fiber.

Multi jet fusion, MJF, is a powder bed fusion process technology introduced by HP in 2016. In the MJF process, the machine deposits down a layer of powdered feedstock on the build platform and an inkjet printhead runs across the powder to deposit a fusing and detailing agent onto it. Then an infrared, IR, heating unit moves across the powder bed. The powder that was exposed to the fusing agent is melted and the powder exposed to the detailing agent remains intact. At the end of the build, the entire powder bed is transferred to a separate processing station where unfused powder is removed by vacuum. MJF compatible materials include polyamides 11 and 12, polypropylene, thermoplastic polyurethane (TPU), and thermoplastic polyamide elastomer (TPA).

Selective heat sintering, SHS, is an AM process that uses a thermal print head to solidify a powder, layer by layer, to create a 3D object. In SHS, powdered feedstock is heated to just below melting point and then spread onto the build platform using a roller. The thermal print head moves across the build platform and melts a cross sectional layer of the part. After the layer is complete, the build platform moves down one layer thickness and fresh layer of powder is deposited on top of previously fused layer. The process is repeated until the part is complete. The finished part is pulled from the build chamber and any unused powder can be reused.

Selective absorption fusion is a polymer powder bed fusion process that uses piezo-electric print heads to deposit high absorption fluid onto a powder bed to define the area of the 3D object. The powder bed is then exposed to the infrared energy and the parts of the powder bed that have high absorption fluid absorb IR energy and are selectively fused to form a layer. Currently, SAF materials include polyamide 11 and 12.

Composite-based additive manufacturing (CBAM) is another AM process that uses powder as feedstock. It is fundamentally different from other powder-based technologies. CBAM uses a carbon fiber or glass fiber sheet and powder to form sheet-fiber reinforced parts. The process begins with the deposition of the long-fiber sheets of carbon or fiberglass on the build platform. The layer of the part is deposited onto the fiber sheets using clear binding fluid and thermal inkjet technology. Next, the polymer powder is deposited on top and adhered to the printing fluid and the fiber sheet underneath. The excess powder is removed and recycled into the machine while the powder coated layer is left behind. The process is repeated for all subsequent layers. When all layers are deposited, the part is heated under load to the melting point of the polymer. The melted polymer particles encase the fibers and fuse the layers together. Then un-bonded portions of sheet fibers are moved through a mechanical or chemical process to reveal the final part. Polymers such as PEEK and polyamide 12 are currently used as matrix materials in CBAM process.

The powders, or strands, for additive manufacturing of articles can be coated with compositions comprising discrete carbon nanotubes of this invention by such means as, but not limited by, creating a slurry of the powder and dispersions of the discrete carbon nanotubes in a liquid medium followed by drying, or spraying the dispersion of discrete carbon nanotubes in a liquid medium onto the powder or strand and drying. Preferably the coating conditions such as the amount of powder in the slurry and concentration of discrete carbon nanotubes and temperature is chosen to control the quality of coating, the amount of coverage of the particle or strand surface with discrete carbon nanotubes, and the thickness of the dried coating. In particular, it is desirable to prevent significant amounts of powder agglomeration during the coating process. By maintaining porosity within the discrete carbon nanotube coating the inter-particle adhesion during the drying process can be better controlled.

An electroactive material is that material used for the purpose of energy storage or energy collection to store or provide energy. Although not limiting, examples of electroactive materials for a lithium-ion battery are transition metal oxides, transition metal salts, silicon, silicon oxide, tin, graphite, hard carbon, gallium, germanium, electroactive ceramics sulfur, graphene, graphene oxide, lithium, and titanium dioxide. A common electroactive material for a cathode of a lithium-ion battery is nickel-manganese-cobalt oxide, NMC.

A method for preparing an electrode of a battery or capacitor may include mixing electroactive material with the composition of this invention and subsequently calendering the mixture to form a free-standing film. In some instances, additional polymers, sometimes named binders, such as but not limited to, polyvinylidenediflouride, polytetrafluoroethylene, acrylonitrile rubber, polyacrylic acid, styrene butadiene and carboxymethyl cellulose, may be employed improve binding of the particles to themselves or to the current collectors.

Additive manufacturing processes suitable for making energy storage devices includes binder jetting where a metal or polymer powder coated with discrete carbon nanotubes is bound together with a fluid layer by layer, the fluid itself may consist of other polymers, and optionally discrete carbon nanotubes in solvents or water.

One embodiment comprises coatings of average thickness from about 5 nanometers to about 2000 nanometers on particles of average diameter less than about 1000 micrometers or curved or planar surfaces wherein the coating is selected from the group consisting of discrete carbon nanotubes. Preferably the coatings selected from the group consisting of discrete carbon nanotubes have an average thickness from about 5 to 1000 nm, and more preferably from about 5 to 500 nm.

Another embodiment comprises coatings of average thickness from about 5 nanometers to about 2000 nanometers wherein the carbon nanotubes further comprise a portion of unbundled, or roped, carbon nanotubes. Preferably the portion of unbundled or roped carbon nanotubes have a bundle or rope dimension of less than about 100 micrometers in size, more preferably less than about 50 micrometers in size, even more preferably less than about 10 micrometers in size, and most preferably less than about 5 micrometers in size. The portion, or mass of the unbundled or roped carbon nanotubes relative to the mass of all the carbon nanotubes in the coating is less than about 20%, preferably less than about 10%, more preferably less than about 5%, and most preferably less than about 1%. The portion and size of the unbundled or roped carbon nanotubes are selected to maintain an average coating thickness of less than about 2000 nanometers.

In some embodiments the coatings are applied onto particles of average diameter less than about 1000 micrometers, preferably less than 200 micrometers, more preferably less than 50 micrometers and most preferably less than 20 microns. In some embodiments the particles are approximately spherical. In some embodiments the particles are hollow. In some embodiments the particles are irregularly shaped. In some embodiments the particles have a dumbbell shape. In some embodiments the particles are strands or fibers. In some embodiments the coating is applied to continuous polymer strands such as, but not limited to those strands made by polymer extrusion. In some embodiments the particle shapes are plates.

In a further embodiment the coating is applied onto the particles wherein at least about 25% of the surface of the particles is coated, preferably at least about 50% of a surface of the particles is coated, more preferably at least about 75% of the surface of the particles is coated, and most preferably at least about 90% of the surface of the particle is coated.

In some embodiments the discrete carbon nanotubes are selected from the group consisting of single wall tubes, double wall tubes, multi-wall tubes, or a combination thereof.

In additional embodiments the particles may include organic polymers. In some embodiments the particles may comprise inorganic species. In some embodiments the organic polymers may comprise elastomers with a glass transition temperature below about 25° C., and polymers with a glass transition temperature above about 25° C. The polymers may be linear molecules, branched molecules, homopolymers, random copolymers, block polymers or combinations thereof. The polymers may be thermoplastic or thermoset. The polymers can be a particulate, strand, film, or sheet form with curved or planar surfaces.

In some embodiments the particles are magnetic or paramagnetic. The magnetic or paramagnetic particles may be made using metal and/or alloy with elements selected from the group consisting of iron, chromium, aluminum, uranium, platinum, copper, cobalt, lithium, nickel, neodymium, oxygen, palladium, manganese, tin, molybdenum, and samarium elements, and mixtures thereof.

In some embodiments the coatings of discrete carbon nanotubes comprise magnetic or paramagnetic species. Preferably the magnetic or paramagnetic species are of average diameter less than about 10 micrometers, more preferably less than about 5 micrometers, most preferably less than about 1 micrometer. Furthermore, if present, the magnetic or paramagnetic particles are present in the coatings of discrete carbon nanotubes at a weight fraction of the coating of more than about 0.1, preferably more than about 0.25, more preferably more than about 0.5 and most preferably more than about 0.75.

The coatings of discrete carbon nanotubes may be applied to particles of gel electrolytes, or elastomers, to improve handleability of the gel electrolytes or elastomers. For example, but not limited to, droplets of gel electrolyte may be coated with discrete carbon nanotubes to enable flowable particles for inclusion in electrodes of energy storage devices. The coated gel electrolytes can be added to electroactive materials in certain proportions that when calendered, or pressed, the gel electrolyte permeates the electroactive material. In a similar manner, solid polymer electrolytes can be coated with discrete carbon nanotubes of this invention and when mixed with electroactive materials can be thermally compressed to give a continuous medium of polymer electrolyte. The coated electrolyte particles can be part of a dry electrode process.

A dry electrode process is one where solvents are not employed during the making of the battery electrode. A typical solvent or liquid process for making a cathode involves drying a slurry of electroactive particles, such as, but not limited to, nickel-manganese-cobalt oxide, n-methylpyrrolidone and polyvinylidenedifluoride as a binder.

The inorganic species are selected from the group consisting of silicon, sulfur, carbon, ceramics, metals, metal oxides, metal salts and mixtures thereof. Electroactive materials are preferred for energy storage devices. Inorganic particles useful for cathodes of lithium-ion batteries include, but not limited to, sulfur, nickel-manganese cobalt oxide and lithium iron phosphate. Inorganic particles useful for anodes include, but not limited to, silicon, lithium, graphite, graphene, and titanium dioxide.

In some embodiments the coating may comprise a porosity (porosity defined as void fraction or that fraction of open space in the coating relative to the whole volume of the coating) of about 0.05 to about 0.95. With surface modified discrete carbon nanotubes the porosity may be enhanced by some or all removal of the surface modification during the process of assembly of the particles into an article. For example, a polymer dispersion agent for the coating of discrete carbon nanotubes could be removed by thermal means or by an electrolyte of a battery.

In a further embodiment a portion of the carbon nanotubes are of length greater than about 0.2 micrometers, preferably of length greater than about 0.5 micrometers and more preferably greater than about 0.8 micrometers. A distribution of lengths where a portion of discrete carbon nanotubes have lengths greater than 50% of the average length is also preferred.

In another embodiment the modality of aspect ratio of the discrete carbon nanotubes is monomodal, bimodal or multimodal.

In yet another embodiment the composition may comprise carbonaceous material. In some embodiments the carbonaceous material may be selected from the group comprising carbon black, carbon fibers, graphite, graphene, reduced graphene, turbostratic graphene, and graphene oxide. The ratio of discrete carbon nanotubes to carbonaceous material selected from the group of carbon black, carbon fibers, graphite, graphene, reduced graphene, turbostratic graphene and graphene oxide is in the range about 0.1:99.9 to about 99.9:0.1 by weight. Preferably the ratio is about 0.25:1 to 99.9:01, more preferably the ratio is about 0.5:1 to about 99.9:0.1 and most preferably in the ratio of 0.75:1 to 99.9:0.1.

In yet another embodiment the coating comprises discrete carbon nanotubes that are dispersed onto the particle, strand, film or sheet with less than about 20% of the mass of the coating in the form of entangled bundles or ropes of carbon nanotubes wherein the bundles or ropes of carbon nanotubes have at least one dimension of size larger than about 5 micrometers. Preferably the mass of the coating in the form of entangled bundles or ropes of carbon nanotubes wherein the bundles or ropes of carbon nanotubes have at least one dimension of size larger than about 5 micrometers is less than about 10% and more preferably less than about 5% of the weight of carbon nanotubes. Even more preferably the mass of the coating in the form of entangled bundles or ropes of carbon nanotubes wherein the bundles or ropes of carbon nanotubes have at least one dimension of size larger than about 2 micrometers is less than about 10% and most preferably less than about 5% of the weight of carbon nanotubes.

In another embodiment the coating composition may comprise surface modification of the discrete carbon nanotubes. The surface modifications may comprise functionalizing the surface of the carbon nanotubes to improve the ability of the coated particles to sinter or join. In some embodiments the modifications may comprise functionalizing the surface of the carbon nanotubes to improve the ability of the coated particles to laser sinter or join.

In some embodiments a surface modification is attached to the surface of the discrete carbon nanotubes by covalent, ionic or hydrogen bonding. In some embodiments the composition disclosed herein further comprises the discrete carbon nanotubes with at least one surface modification selected from the group of molecules containing oxygen, silicon, titanium, zirconium, sulfur, phosphorous or nitrogen elements.

In some embodiments the surface modification is selected from the group of molecules consisting of anionic, cationic, nonionic and zwitterionic surfactants, polyvinyl alcohols, copolymers of polyvinyl alcohols and polyvinyl acetates, polyvinylpyrrolidones and their copolymers, carboxymethyl cellulose, carboxypropyl cellulose, carboxymethyl propyl cellulose, hydroxyethyl cellulose, polyetherimines, polyethers, starch, and mixtures thereof.

In some embodiments the surface modification disclosed herein has a value of Hansen Solubility Parameter dispersion parameter within about 2 J^{0.5} m^{-1.5} the value of the Hansen Solubility Parameter dispersion parameter of the polymer particle or film. In some embodiments the surface modification is miscible with a polymer comprising the particle or film. In some embodiments the surface modification allows chemical interaction between the composition of the particle and the surface modification.

Some embodiments comprise selecting a composition for the surface modification of the discrete carbon nanotubes wherein the surface modification can be at least partially removed, or partially modified, during sintering, or joining, utility of the particle. For example, a dispersing agent for discrete carbon nanotubes may be selected so that the dispersing agent is soluble in the electrolyte of an energy storage device. By this means the permeability of electrolyte through the coating is increased.

In another embodiment, the surface modification moiety is selected so that it does not provide a continuous film between the discrete carbon nanotubes. The surface modification moiety can be selected so that the volume fraction of the surface modification moiety is less than about 0.8 of the total volume of discrete carbon nanotubes and surface modification moiety, preferably the volume fraction of the surface modification moiety is less than about 0.6 of the total volume of discrete carbon nanotubes and surface modification moiety, more preferably the volume fraction of the surface modification moiety is less than 0.4 of the total volume of discrete carbon nanotubes and surface modification moiety, and most preferably the volume fraction of the surface modification moiety is less than about 0.2 of the total volume of discrete carbon nanotubes and surface modification moiety.

In one other embodiment a part made from sintering or joining the coated particles, strands or films has a surface resistance of less than about 10 billion ohms-square, preferably less than about 10 million ohm-square, more preferably less than about 10,000 ohm-square and most preferably less than about 1000 ohm-square.

In another embodiment the coating of discrete carbon nanotubes are on particles, wherein the particles are sub-micrometer in size in at least one dimension.

In another embodiment the particles coated with discrete carbon nanotubes are mixed with uncoated particles. Preferably the weight ratio of coated particles to uncoated particles is greater than about 0.1, more preferably greater than about 0.25, even more preferably greater than about 0.5, and most preferably greater than about 0.75.

In one other embodiment the coated particles are assembled to make an electrode of an energy storage or collection device using a dry, or liquid, electrode process.

In some embodiments parts made using the coatings of this invention produce parts with enhanced properties, such as, but not limited to, mechanical, thermal, electrical, magnetic, and chemical properties, and improved processing attributes, such as but not limited to, more laser energy absorption, increased particle flowability, and higher green strength.

### EXAMPLES

### Example 1

Coating of an elastomeric block polymer of Nylon 12 and poly (tetramethylene oxide), Vestasint 3045D.

The polymer structure of Vestasint 3045D is considered to consist of a minor block polymer phase of nylon 12 of whose domains are crystallized by about 20-30% wt. of the Nylon 12, and a major polymer phase of blocks of poly (tetramethylene oxide) which may also has some small amount of crystallinity. The elastomeric behavior of the article made from Vestasint 3045D stems from a major portion of the poly (tetramethylene oxide) which has a glass transition temperature <−50° C. effectively crosslinked by nanoscale domains of the semi-crystalline Nylon 12.

Dispersion of oxidized discrete multiwall carbon nanotubes with polyvinylpyrrolidone, PVP.

Discrete oxidized multiwall carbon nanotubes were made from CNano Flotube 9000 using nitric acid (65% nitric acid concentration) at a reaction temperature of 90 degrees centigrade and 2.5 hours, followed by removal of the acid by filtering, and washing by deionized water to a pH of 3.5. The oxidized carbon nanotubes were then subjected to intensive mixing in a slurry with water to give discrete oxidized carbon nanotubes. The amount of oxidized species of the functionalized carbon nanotubes was determined as 2.3% by weight using the TGA method detailed previously. An electron micrograph of a dried sample of the discrete oxidized multiwall carbon nanotubes is shown in FIG. 1 demonstrating the porosity of the discrete oxidized carbon nanotubes and the presence of many open ends within the discrete oxidized carbon nanotubes.

A 3% wt. oxidized discrete carbon nanotube dispersion was made by taking 20.45 g of 4.4% solids aqueous wet cake of the above oxidized discrete multiwall carbon nanotubes and adding 9.55 g of 0.45 g of polyvinylpyrrolidone, PVP 10,000 Daltons dissolved in 9.15 g water in a 50 cc glass bottle. The weight ratio of PVP to discrete carbon nanotubes is 0.5 to 1. The bottle and contents were then sonicated using a sonicator bath for 3 hours keeping the temperature under 40° C. This process is repeated to make larger volumes for coating the powders as needed. The polyvinylpyrrolidone of Molecular weight 10,000 daltons is selected as it has compatibility with the Vestasint. The Hansen Solubility Parameters for the dispersion, polar and hydrogen bonded components for PVP are 17.4, 8.8 and 14.9, respectively. For Nylon 12 the dispersion, polar and hydrogen bonded components of the Hansen solubility parameters are 18.5, 8.1 and 9.1, respectively.

Coating of Vestasint 3054D powder.

The appropriate weight of discrete oxidized carbon nanotubes in dispersion was added to make a range of coating thicknesses on 60 g total of coated powder. The range of discrete carbon nanotubes to polymer was 0.05 to 2% by weight. Water was added to make a total weight of 130 g and the slurry mixed using a Thinky mixer at 2000 rpm for 3 minutes. The slurry was then spread thinly in a glass tray and dried at 100° C. for four hours in a convection oven.

Differential scanning calorimetry, DSC, was performed using a TA DSC Q20 instrument by first placing about 10 mg the coated pellets in the DSC pan, heating to 180° C. at 10° C./min, then cooling to −100° C. at 5° C./min followed by reheating to 180° C. at 10° C./min. The glass transition temperature, peak melting point, endotherm of melting, peak temperature of recrystallization and exotherm of recrystallization were recorded. The heat of fusion for 100% crystalline nylon 12 was taken as 246 J/g. ASTM E1356-08 (2014) is used as a standard test method for assignment of the glass transition temperatures by differential scanning calorimetry.

Optical pictures of the powders before and after sintering were taken using a Nikon camera.

Secondary electron microscopy, SEM, was performed on the powders to determine the nature of the coating. The powders were pressed onto sticky carbon discs placed on aluminum stubs. An electron beam energy of 2 or 5KV was selected with a working distance around 9 mm.

The Vestasint 3054D particle diameter ranged from about 30-150 micrometers with about 70 micrometers being the median value. The coating thicknesses of discrete carbon nanotubes were estimated assuming an average 70 micrometers diameter spherical particle, the relative weight of the carbon nanotubes to the polymer and the packing density of the dried discrete multiwall carbon nanotube coating taken to be 0.25 g/cc. The value of the packing density of the carbon nanotubes coated on particles can be gained from electron microscopy studies of microtomed sintered particles or by delamination of the coatings from the particles.

TABLE 1
Calculated thickness of discrete oxidized carbon nanotube coating.

| | | | | | | |
|---|---|---|---|---|---|---|
| Wt. % carbon | 0.05 | 0.1 | 0.2 | 0.5 | 1.0 | 2.0 |
| nanotubes | | | | | | |
| Thickness nm | 22 | 45 | 92 | 232 | 463 | 926 |

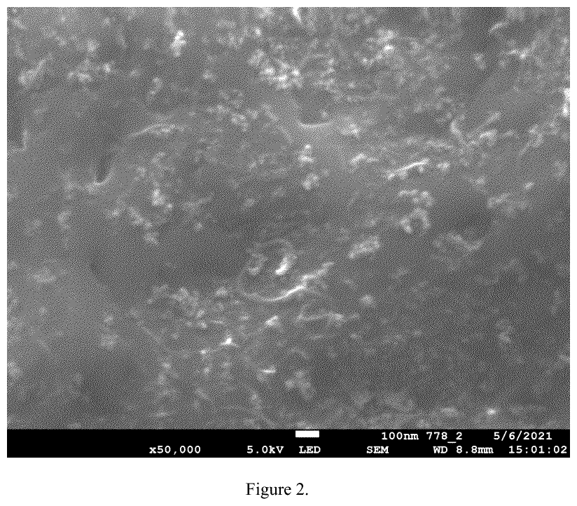

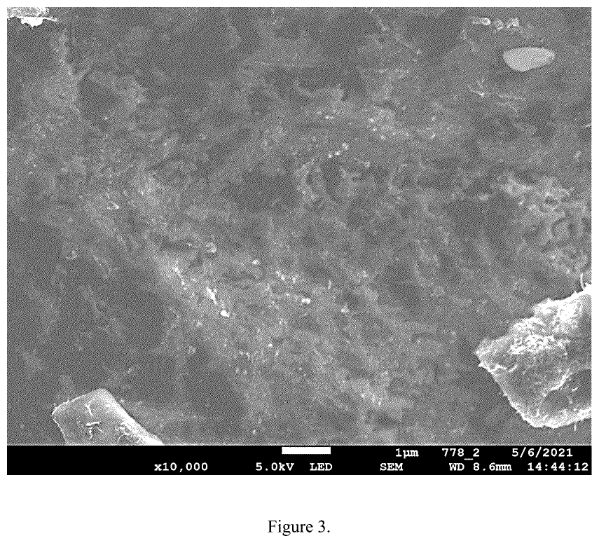

FIG. 2 shows an electron micrograph at 50,000× magnification of a monolayer of discrete oxidized multiwall carbon nanotube coating on a powder particle of Vestasint 3054D. The polyvinylpyrrolidone is seen as globules approximately 20 to 40 nanometers in diameter at the tube surface. The globular nature of the PVP shows that it has not formed a continuous coating, i.e., porosity with the discrete carbon nanotube is maintained. FIG. 3 shows the discrete carbon nanotube coating at 0.1% wt. discrete carbon nanotubes.

Nylon 12 polymer itself has a glass transition temperature, Tg, around 50° C. and a melting peak at 175° C. With the lower molecular weight of the block nylon 12 in Vestasint compared to homopolymer Nylon 12 the melting point is expected to be decreased and the Tg can be lowered also compared to the homopolymer nylon 12.

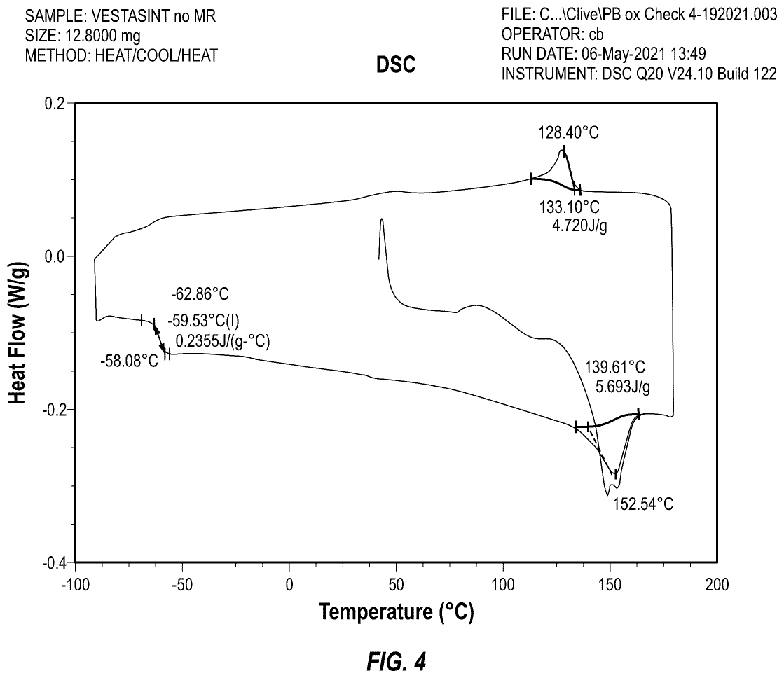

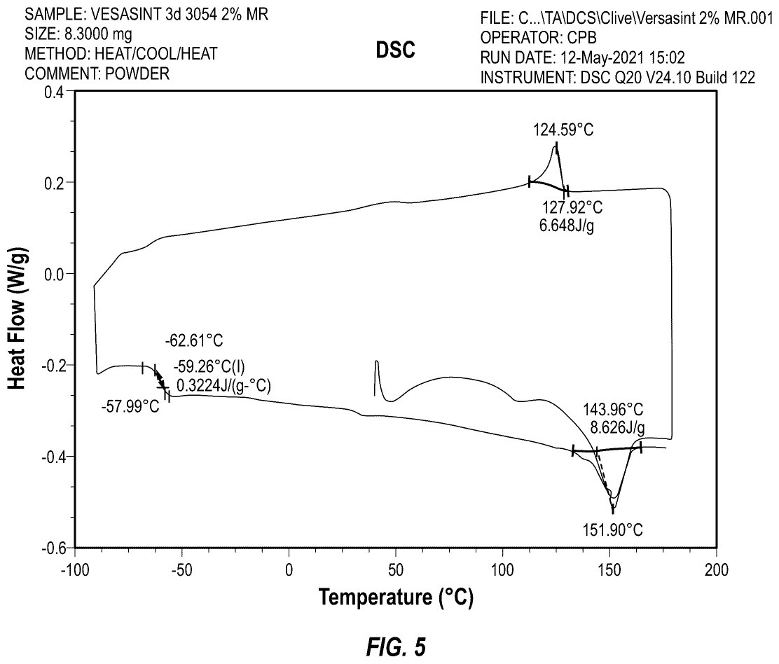

FIGS. 4 and 5 show thermograms of the heat-cool-heat cycle for uncoated and coated Vestasint 3054D, respectively. The differential scanning calorimeter thermogram of the first heating cycle seen in FIG. 4 shows that particle fusion is complete on melting of the particles starting around 140° C. On cooling the peak temperature of crystallization of the nylon 12 domain occurs at 128° C. for the Vestasint with no discrete carbon nanotube coating and around 125° C. with 2% weight of the discrete carbon nanotube coating, FIG. 5.

Another small thermic event occurs at around 50° C. on cooling. On reheating there is a small endothermic event, named Tm1 in Table 2, in the range 35 to 41.5° C. These two events on cooling and heating are due to the Tg of the nylon phase and/or small amounts of crystallization of the poly (tetramethylene oxide). The Tg, on heating is shown as around −58° C. is ascribed to the largely amorphous PTMO phase, then melting of the nylon 12 block with peak melting temperature around 152° C. The results of specimen for the 1st cooling and 2nd reheating are given in Table 2.

TABLE 2
Collected DSC data of Vestasint 3054D
particles, uncoated and coated.

| % wt. | Tg | Tm1 | Tmpeak | ΔHm | Tc | ΔHc |
|---|---|---|---|---|---|---|
| coating | ° C. | ° C. | ° C. | J/g | ° C. | J/g |
| 0 | −58.1 | 41.5 | 152.5 | 5.7 | 128.4 | 4.7 |
| 0.05 | −58.0 | 41.5 | 153.8 | 9.3 | 128.4 | 7.6 |
| 0.1 | −58.3 | 41.5 | 152.8 | 9.3 | 128.1 | 7.6 |
| 0.2 | −57.4 | 35.4 | 153.2 | 9.6 | 127.2 | 7.9 |
| 0.5 | −57.6 | 35.4 | 152.9 | 9.5 | 126.7 | 7.7 |
| 1 | −58.0 | 35.4 | 150.3 | 9.6 | 125.6 | 7.8 |
| 2 | −59.9 | 35.4 | 151.9 | 8.6 | 127.9 | 6.6 |

Seen from the values of the heat of fusion on melting ΔHm and heat of fusion on recrystallization ΔHc in Table 2, the coating of oxidized discrete carbon nanotubes clearly increases the amount of crystallinity of the Nylon 12 domains.

The Vestasint 3054D particles with coatings of discrete oxidized carbon nanotubes in the range 0.05 to 2% weight of the particles were observed to be well fused together after heating to 180° C. The fused films were observed to decrease in the glossiness of the surface as the initial discrete carbon nanotube coating increased in thickness. With an interparticle coating thickness of about 2 micrometers the Vestasint polymer was still able to diffuse through the coating and make a coherent film.

### Example 2

Coating discrete oxidized carbon nanotubes onto Luvosint HTN particles.

Luvosint HTN is a cryogenically ground high temperature semi-crystalline nylon copolymer made from hexamethylenediamine and isophthalic acid. The average particle diameter was determined as 73 micrometers. The oxidized discrete multiwall carbon nanotubes employed were the same as example 1.

An aqueous dispersion of 3% wt. oxidized discrete multiwall carbon nanotubes and 1.05% wt. polyvinylalcohol of Mw about 30,000 Daltons and hydrolysis value of about was made using a sonicator bath for 3 hours keeping the temperature under 40° C.

A series of coatings of 0.05, 0.1, 0.25, and 0.5 wt. oxidized discrete carbon nanotubes in the final dried material. The appropriate weight of the concentrated solution for coating 60 g of powder was added to water to make 70 g of solution, then added to 60 g of the Luvosint HTN. The slurry was hand mixed, then mixed in a Thinky mixer at 2000 rpm for 3 minutes. The resulting mixture was spread thinly in a glass tray and dried at 100° C. for four hours in a convection oven, followed by 2 hours at 80° C. under vacuum. The powders were easily crushed with a glass bottle to give fine powders.

The coating thicknesses of the discrete carbon nanotubes were estimated assuming a 73 micrometers average diameter spherical particle, density of particle 1.14 g/cc and the packing density of the discrete carbon nanotubes to be 0.25 g/cc.

TABLE 2
Calculated thickness of coating layer of discrete
carbon nanotubes on Luvosint HTN particles.

| | Weight % of discrete carbon nanotubes | | | |
|---|---|---|---|---|
| | 0.05 | 0.1 | 0.25 | 0.5 |
| coating thickness nm | 26 | 54 | 137 | 275 |

Secondary electron microscopy, SEM, was performed on the powders to observe the coating. The powders were pressed onto sticky carbon discs placed on aluminum stubs. SEM pictures can be difficult to obtain because of electron charging on non-conductive polymers. Electron charging can give rise to smearing or waviness. Coatings of higher loadings were easier to image at high magnifications. A typical condition was 1 KV electron beam with a working distance around 9 mm.

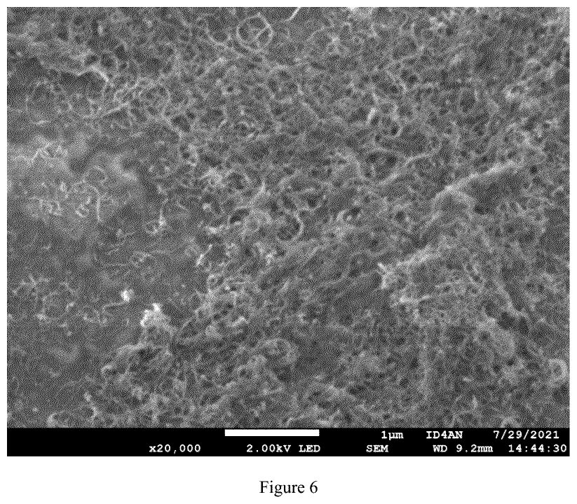

At 0.25% wt. of discrete oxidized multiwall carbon nanotubes coating on the powder, it was observed in some small regions of the surface of the particle that the carbon nanotube coating has separated from the Luvosint HTN, electron micrograph FIG. 6. Some discrete carbon nanotubes, however, remain adhered to the surface of the nylon where the thicker coating has been removed. This illustrates that polyvinylalcohol is suitable as a polymer surfactant for the dispersion of discrete carbon nanotubes as well as to provide adhesion of the discrete carbon nanotubes to the Nylon particle.

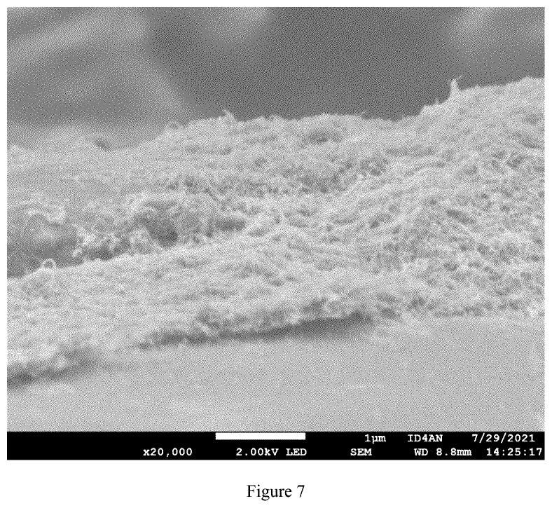

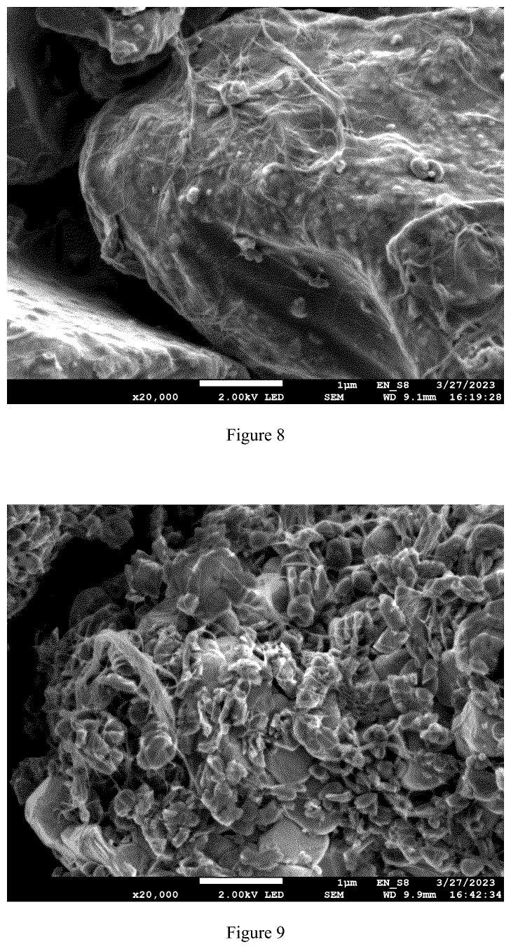

The electron micrograph FIG. 7 shows the coating of 0.5% wt. discrete oxidized carbon nanotube and polyvinylalcohol on a Luvosint HTN particle where the particle was abraded to remove part of the coating and determine the coating layer thickness. The thickness of the coating was determined as 313 nm. The coating was also observed to be porous throughout the thickness.

DSC was performed by first placing about 10 mg the coated pellets in the DSC pan, heating to 300° C. at 10° C./min, then cooling to 0° C. at 10° C./min followed by reheating to 300° C. at 10° C./min. The glass transition temperature, peak melting point, endotherm of melting, peak temperature of recrystallization and exotherm of recrystallization were recorded. The heat of fusion for 100% crystalline nylon was taken as 246 J/g. The glass transition temperature mid-point is 89.5° C. on reheating.

TABLE 3
DSC results

| % wt. discrete | | | | | |
|---|---|---|---|---|---|
| oxidized carbon | Tg ° C. | Tc peak | | Tm peak | |
| nanotube coating | 2nd heat | ° C. | ΔHc J/g | ° C. | ΔHm J/g |
| 0 | 89.5 | 163.0 | 42.6 | 237.5 | 51.5 |
| 0.05 | 87.2 | 166.9 | 43.7 | 236.4 | 53.9 |
| 0.1 | 88.3 | 165.1 | 35.7 | 235.9 | 44.4 |
| 0.25 | 85.2 | 167.9 | 50.3 | 236.2 | 63.2 |
| 0.5 | 88.6 | 173.8 | 48.9 | 236.9 | 56.8 |

The DSC of the first heating cycle shows that particle sintering begins in the range 200° C. for the uncoated Luvosint HTN powder and the particle sintering slightly increases with discrete carbon nanotube coating content, going to about 205° C. for the 0.5% wt. coated powder. The values of the Tg and Tm peak are essentially the same independent of the coating in the range of discrete carbon nanotubes used here. The increasing Tc values are considered the result of the improved heat transport of the powders with discrete carbon nanotube coatings. The values of the heat of fusion would suggest a value for the % wt. crystallinity of 20-22%.

After sintering the particles at 300° C. the 0.05 and 0.1% wt. discrete carbon nanotube coated powders gave glossy surfaces whereas the 0.25 and 0.5% wt. discrete carbon nanotube coated powders were dull. In each case up to 0.5% wt. the coated powders gave a coherent film after cooling, i.e., the aromatic nylon permeated through the coating and gave good interparticle adhesion.

2-electrode resistance measurements using a digital ohmmeter (capable of measuring up to 25 megaohms) of the powders sintered on an aluminum plate gave values of 6 megaohms for the 0.25% wt. discrete oxidized carbon nanotube coating and 0.6 megaohms for the 0.5% wt. discrete oxidized carbon nanotube coating on Luvosint HTN particles.

### Example 3

Coating of powders of polyetherketone with carbon fiber filler.

The polyetherketone has an estimated chopped carbon fiber content of 12% wt. The average particle size is taken as 70 micrometers. The oxidized discrete multiwall carbon nanotubes employed were the same as those used in example 1.

An aqueous dispersion of 3% wt. oxidized discrete multiwall carbon nanotubes and 0.75% wt. polyvinylpyrrolidone of molecular weight, Mw about 40,000 Daltons was made using a sonicator bath for 3 hours keeping the temperature under 40° C.

A series of coatings of 0.05, 0.1, 0.15, 0.2, 0.25, 0.3, 0.35 and 0.4% wt. oxidized discrete carbon nanotubes to the PEK carbon fiber powders were made. The appropriate weight of the concentrated solution of discrete oxidized carbon nanotubes for coating 60 g of powder was added to water to make 70 g of solution, then added to 60 g of the powder. The slurry was hand mixed, then mixed in a Thinky mixer at 2000 rpm for 3 minutes. The resulting mixture was spread thinly in a glass tray and dried at 100° C. for four hours in a convection oven, followed by 2 hours at 80° C. under vacuum. The powders were easily crushed with a glass bottle to give fine powders.

The coatings were observed to be uniformly covering the surface of the powders by optical microscopy. On sintering the particles using a hot plate, films with good mechanical integrity were obtained. At 0.25% wt. and higher loadings of the coating on the particle, after sintering the electrical resistivity of the surface was determined to be less than 10⁸ ohm-square, and thus suitable for making articles with electrostatic dissipation performance.

### Example 4

Coating of a silicon anode material (MSE supplies).

10 g of single wall carbon nanotubes (Korbon) and 3 g of sodium carboxymethylcellulose, CMC, approximate molecular weight 30,000 daltons, (Ashland) were added to 990 g of de-ionized water and passed through a high shear mixer while keeping the temperature less than 35° C., until a stable dispersion of discrete single wall carbon nanotubes was obtained as observed by optical microscopy at magnification 168×. A slurry of the silicon anode material was made using 1 g of the silicone anode, and 1.1 g of the single wall carbon nanotube CMC dispersion. This gave a silicon anode material to single wall carbon nanotube weight ratio of 1:0.011. The slurry was dried at 110° C. for 1 hour with intermediate stirring.

An electron micrograph at 20,000× magnification, FIG. 7, showed the discrete single wall carbon nanotubes to coat the silicon anode particles. Many of the single wall carbon nanotubes were in the form of thin ropes. Single wall carbon nanotube agglomerations of diameter greater than 5 micrometers were not observed.

A pressed layer of the anode particles coated with 1.1% wt. discrete single wall carbon nanotubes gave a surface resistance of about 70 ohm-square compared to the uncoated anode particles which gave a resistance of about 3 kiloohm-square.

### Example 5

Coating of nickel-manganese-cobalt oxide material (BASF NMC 523)

The same dispersion of single wall carbon nanotubes as example 4 was used. A slurry of the NMC cathode material was made using 5.9 g of the NMC material, and 1.85 g of the single wall carbon nanotube CMC dispersion. This gave an NMC cathode material to single wall carbon nanotube weight ratio of 1:0.0031. The slurry was dried at 110° C. for 1 hour with intermediate stirring.

An electron micrograph at 20,000× magnification, FIG. 8, showed the discrete single wall carbon nanotubes to coat the NMC cathode electroactive material particles. Many of the single wall carbon nanotubes were in the form of thin ropes. Single wall carbon nanotube agglomerations of diameter greater than 5 micrometers were not observed.

A pressed layer of the NMC particles coated with discrete single wall carbon nanotubes at 0.31% by weight gave a surface resistance of about 200 ohm-square compared to the uncoated NMC cathode particles which gave a resistance greater than 25 megaohm-square.

### Embodiments

1. A composition for energy storage, and additive manufacturing comprising:

a coating comprising discrete carbon nanotubes wherein the coating comprises an average thickness of from about 5 nanometers to about 2000 nanometers and wherein the coating is on at least about 50% of the surface area of particles and wherein the particles have an average diameter less than about 1000 micrometers.

2. The composition of embodiment 1, wherein the particles having the average diameter of less than about 1000 micrometers are selected from the group consisting of organic polymers, inorganic species, and any mixture thereof.

3. The composition of embodiment 2, wherein the organic polymers are elastomers having a glass transition temperature of less than about 25° C.

4. The composition of embodiment 2, wherein the organic polymers are thermoplastics having a glass transition temperature of greater than about 25° C.

5. The composition of embodiment 2, wherein the inorganic species are selected from the group consisting of silicon, sulfur, carbon, ceramics, metals, metal oxides, metal salts, transition metal oxides, transition metal salts, silicon oxide, tin, graphite, hard carbon, gallium, germanium, electroactive ceramics, graphene, graphene oxide, lithium, titanium dioxide. and any mixture thereof.

6. The composition of embodiment 5 wherein the inorganic species is an electroactive material.

7. The composition of embodiment 1, wherein the coating has a porosity of about 0.05 to about 0.95.

8. The composition of embodiment 1, wherein the carbon nanotubes are selected from a group consisting of single wall, double wall, multiwall carbon nanotubes, and any mixture thereof.

9. The composition of embodiment 1, further comprising a carbonaceous material selected from the group of carbon black, carbon fibers, graphite, graphene, reduced graphene, carbon nanorods, turbostratic graphene, graphene oxide, and any mixture thereof.

10. The composition of embodiment 8, wherein the modality of aspect ratio of the discrete carbon nanotubes is monomodal.

11. The composition of embodiment 8, wherein the modality of aspect ratio of the discrete carbon nanotubes is at least bimodal.

12. The composition of embodiment 8, wherein a majority of the carbon nanotubes have a length of greater than about 0.2 micrometers.

13. The composition of embodiment 1, wherein the coating further comprises carbon nanotubes in the form of entangled bundles or ropes and wherein the bundles or ropes of carbon nanotubes have at least one dimension of size less than about 10 micrometers, and wherein the bundles or ropes comprise less than about 20% of the total mass of the coating.

14. The composition of embodiment 9, wherein the weight ratio of discrete carbon nanotubes to carbonaceous material is from about 1:99 to about 99:1.

15. The composition of embodiment 1, wherein at least a portion of the discrete carbon nanotubes comprise surface modified discrete carbon nanotubes.

16. The composition of embodiment 15, wherein at least a portion of the surface modified discrete carbon nanotubes are is attached to the particles having an average diameter of less than about 1000 micrometers by covalent bonding, ionic bonding, hydrogen bonding, or any mixture thereof.

17. The composition of embodiment 15, wherein the surface modified discrete carbon nanotubes comprise a surface modification selected from the group consisting of molecules containing the elements oxygen, silicon, titanium, zirconium, sulfur, phosphorous, nitrogen, or any mixture thereof.

18. The composition of embodiment 15, wherein the surface modified discrete carbon nanotubes comprise a surface modification with a compound selected from the group consisting of anionic, cationic, nonionic and zwitterionic surfactants, polyvinyl alcohols, copolymers of polyvinyl alcohols and polyvinyl acetates, polyvinylpyrrolidones and their copolymers, carboxymethyl cellulose, carboxypropyl cellulose, carboxymethyl propyl cellulose, hydroxyethyl cellulose, polyetherimines, polyethers, starch, and any mixture thereof.

19. The composition of embodiment 18, wherein the surface modification of the discrete carbon nanotubes has a value of Hansen Solubility Parameter dispersion parameter within about 2 J^{0.5} m^{-1.5} the value of the Hansen Solubility Parameter dispersion parameter of the particles having an average diameter of less than about 1000 micrometers.

20. The composition of embodiment 15, further comprising an electrolyte and wherein the surface modification of the discrete carbon nanotubes has a value of Hansen Solubility Parameter dispersion parameter within about 2 J^{0.5} m^{-1.5} the value of the Hansen Solubility Parameter dispersion parameter of the electrolyte.

21. The composition of embodiment 18, wherein the surface modification is miscible with the particles having an average diameter of less than about 1000 micrometers.

22. The composition of embodiment 15, wherein the surface modified discrete carbon nanotubes and the particles of average diameter of less than about 1000 micrometers are selected to facilitate chemical interaction between the surface modified discrete carbon nanotubes and the particles of average diameter of less than about 1000 micrometers.

23. The composition of embodiment 22, wherein the surface modified discrete carbon nanotubes and the particles of average diameter of less than about 1000 micrometers are chemically bonded.

24. The composition of embodiment 18, wherein the surface modification is miscible in an electrolyte.

25. An article comprising the composition of embodiment 1.

26. The article of embodiment 25 wherein the composition is joined or sintered.

27. The composition of embodiment 15, wherein the volume fraction of surface

modification is less than about 0.8 of the total volume of discrete carbon nanotubes and surface modification.

28. The article of embodiment 26, wherein the article has a surface resistance of less than about 10 billion ohms-square.

29. The composition of embodiment 1, wherein the particles having an average diameter less than about 1000 micrometers further comprise an electrolyte selected from the group consisting of a gel, a solid, or any mixture thereof.

30. The composition of embodiment 1, wherein at least a portion of the particles having an average diameter less than about 1000 micrometers are below one micrometer in size in at least one dimension.

31. The composition of embodiment 1, further comprising uncoated particles and wherein the ratio of coated particles to uncoated particles is in the range 10:90 to 99:1 based on total weight of the particles.

32. The composition of embodiment 1, wherein the coated particles are assembled to make an electrode of an energy storage or collection device using a dry or liquid electrode process.

33. The composition of embodiment 1, wherein the composition is sintered or joined with a laser.

34. The composition of embodiment 1, wherein the composition comprises at least one magnetic metal and/or alloy.

35. The composition of embodiment 34, wherein the magnetic metal and/or alloy thereof is selected from the group consisting of iron, chromium, aluminum, uranium, platinum, copper, cobalt, lithium, nickel, neodymium, oxygen, palladium, manganese, tin, molybdenum, and samarium elements, and mixtures thereof.

1. A composition for energy storage, and additive manufacturing comprising:
a coating comprising discrete carbon nanotubes wherein the coating comprises an average thickness of from about 5 nanometers to about 2000 nanometers and wherein the coating is on at least about 50% of the surface area of particles and wherein the particles have an average diameter less than about 1000 micrometers.

2. The composition of claim 1, wherein the particles having the average diameter of less than about 1000 micrometers are selected from the group consisting of organic polymers, inorganic species, and any mixture thereof.

3. The composition of claim 2, wherein the organic polymers are elastomers having a glass transition temperature of less than about 25° C.

4. The composition of claim 2, wherein the organic polymers are thermoplastics having a glass transition temperature of greater than about 25° C.

5. The composition of claim 2, wherein the inorganic species are selected from the group consisting of silicon, sulfur, carbon, ceramics, metals, metal oxides, metal salts, transition metal oxides, transition metal salts, silicon oxide, tin, graphite, hard carbon, gallium, germanium, ceramics, graphene, graphene oxide, lithium, titanium dioxide, calcium carbonate, talc, magnesium carbonate, Wollastonite, glass beads, glass fibers, glass flakes, fly ashes, dolomite, barium sulfate, aluminum hydroxide, halloysite, mica, hematite, and any mixture thereof.

6. The composition of claim 5 wherein the inorganic species is an electroactive material.

7. The composition of claim 1, wherein the coating has a porosity of about 0.05 to about 0.95.

8. The composition of claim 1, wherein the carbon nanotubes are selected from a group consisting of single wall, double wall, multiwall carbon nanotubes, and any mixture thereof.

9. The composition of claim 1, further comprising a carbonaceous material selected from the group of carbon black, carbon fibers, graphite, graphene, reduced graphene, carbon nanorods, turbostratic graphene, graphene oxide, and any mixture thereof.

10. The composition of claim 8, wherein the modality of aspect ratio of the discrete carbon nanotubes is monomodal.

11. The composition of claim 8, wherein the modality of aspect ratio of the discrete carbon nanotubes is at least bimodal.

12. The composition of claim 8, wherein a majority of the carbon nanotubes have a length of greater than about 0.2 micrometers.

13. The composition of claim 1, wherein the coating further comprises carbon nanotubes in the form of entangled bundles or ropes and wherein the bundles or ropes of carbon nanotubes have at least one dimension of size less than about 10 micrometers, and wherein the bundles or ropes comprise less than about 20% of the total mass of the coating.

14. The composition of claim 9, wherein the weight ratio of discrete carbon nanotubes to carbonaceous material is from about 1:99 to about 99:1.

15. The composition of claim 1, wherein at least a portion of the discrete carbon nanotubes comprise surface modified discrete carbon nanotubes.

16. The composition of claim 15, wherein at least a portion of the surface modified discrete carbon nanotubes is attached to the particles having an average diameter of less than about 1000 micrometers by covalent bonding, ionic bonding, hydrogen bonding, or any mixture thereof.

17. The composition of claim 15, wherein the surface modified discrete carbon nanotubes comprise a surface modification selected from the group consisting of molecules containing the elements oxygen, silicon, titanium, zirconium, sulfur, phosphorous, nitrogen, or any mixture thereof.

18. The composition of claim 15, wherein the surface modified discrete carbon nanotubes comprise a surface modification with a compound selected from the group consisting of anionic, cationic, nonionic and zwitterionic surfactants, polyvinyl alcohols, copolymers of polyvinyl alcohols and polyvinyl acetates, polyvinylpyrrolidones and their copolymers, carboxymethyl cellulose, carboxypropyl cellulose, carboxymethyl propyl cellulose, hydroxyethyl cellulose, polyetherimines, polyethers, starch, and any mixture thereof.

19. The composition of claim 18, wherein the surface modification of the discrete carbon nanotubes has a value of Hansen Solubility Parameter dispersion parameter within about 2 J^{0.5} m^{-1.5} the value of the Hansen Solubility Parameter dispersion parameter of the particles having an average diameter of less than about 1000 micrometers.

20. The composition of claim 15, further comprising an electrolyte and wherein the surface modification of the discrete carbon nanotubes has a value of Hansen Solubility Parameter dispersion parameter within about 2 J^{0.5} m^{-1.5} the value of the Hansen Solubility Parameter dispersion parameter of the electrolyte.

21. The composition of claim 16, wherein the surface modified discrete carbon nanotubes and the particles of average diameter of less than about 1000 micrometers are chemically bonded.

22. The composition of claim 18, wherein the surface modification compound is miscible in an electrolyte.

23. The composition of claim 15, wherein the volume fraction of surface modification is less than about 0.8 of the total volume of discrete carbon nanotubes and surface modification.

24. The composition of claim 1, wherein the particles having an average diameter less than about 1000 micrometers further comprise an electrolyte selected from the group consisting of a gel, a solid, and any mixture thereof.

25. The composition of claim 1, wherein the composition comprises at least one magnetic metal and/or alloy wherein the magnetic metal and/or alloy thereof is selected from the group consisting of iron, chromium, aluminum, uranium, platinum, copper, cobalt, lithium, nickel, neodymium, oxygen, palladium, manganese, tin, molybdenum, and samarium elements, and mixtures thereof.
